(19) United States
(12) Patent Application Publication
(10) Pub. No.: US 2023/0422093 A1
(43) Pub. Date: Dec. 28, 2023

(54) Communication Method and Communication Participant

(71) Applicant: Fraunhofer-Gesellschaft zur Foerderung der angewandten Forschung e.V., Munich (DE)

(72) Inventors: Juergen HUPP, Erlangen (DE); Oliver HAALA, Erlangen (DE); Andreas FROTZSCHER, Dresden (DE); Hannes ELLINGER, Dresden (DE); Stefan LIPP, Erlangen (DE); Frank BURKHARDT, Erlangen (DE)

(21) Appl. No.: 18/464,843

(22) Filed: Sep. 11, 2023

Related U.S. Application Data
(63) Continuation of application No. PCT/EP2022/056167, filed on Mar. 10, 2022.

(30) Foreign Application Priority Data
Mar. 12, 2021 (EP) 21162296.4

(51) Int. Cl. H04W 28/06; H04L 69/22

(52) U.S. Cl. CPC H04W 28/065; H04L 69/22

(57) ABSTRACT

Communication method, comprising: transmitting at least one data packet with a header and a coded packet, wherein the header includes, from a group, at least one first information relevant for interpreting the coded packet, wherein the group includes one or several of the following information: —information with respect to one or several sources of the coded packet and information with respect to one or several sinks of the coded packet or information with respect to one or several sources or sinks of the coded packet in combination with information with respect to a transmission direction or with respect to one or several further communication partners; —a coding vector, wherein the coding vectors is included separately, included integrally, pre-specified, or referenced, wherein coding coefficients are allocated to the coding vector; and deriving, from the at least one first information under consideration of pre-configured information, one second information of the group that is relevant for interpreting the coded packet.

### CROSS-REFERENCES TO RELATED APPLICATIONS

This application is a continuation of copending International Application No. PCT/EP2022/056167, filed Mar. 10, 2022, which is incorporated herein by reference in its entirety, and additionally claims priority from European Application No. EP 21 162 296.4, filed Mar. 12, 2021, which is incorporated herein by reference in its entirety.

### BACKGROUND OF THE INVENTION

Embodiments of the present invention relate to a communication method as well as to a communication participant such as a transmitter or a receiver, or a transceiver, and to a corresponding system with one or several communication participants. Advantageous embodiments relate to a method for efficient network coded cooperation in real-time radio systems or to network coding in general.

Radio systems, in particular in industrial applications with fast reaction times or strong requirements as to security or availability, are confronted with high demands in regard to packet-loss rate, data rate, or latency in bidirectional transmissions.

FIG. 1 shows an example radio system consisting of five radio nodes 10A to 10D. Examples for such nodes are sensors or actuators in movable scenarios, such as (engine) controllers. Examples include sensors or actuators in movable scenarios or (engine) controllers.

In order to realize a deterministic temporal behavior in radio transmission, scheduling methods or time-multiplex methods (Time Division Multiple Access, TDMA) are usually employed. In the case of faultless transmission, this leads to a deterministic latency, or cycle time. In case of an interference of the transmission, measures have to be taken. These measures cannot violate the time requirements for the transmission, since external controller systems otherwise react to the transmission interference, e.g. with an emergency operation or switch-off of the machine.

The measures for increasing the robustness are usually carried out in different ways:
channel coding to improve an individual link
retransmission or ARQ/HARQ methods with packet repetition within the cycle time.
antenna diversity to utilize several transmission paths in case of multi-path propagation
relaying and cooperative methods (Cooperative Communication, CC), i.e. packet forwarding through other radio nodes (RN) as forwarding intermediate node. Path redundancy also results through this intermediate node.

For example, such a cooperative communication is shown in FIG. 2as.

FIG. 2a shows several transmitters 10S1 to 10SM transmitting a data packet to a receiver 10E. Several relay nodes 10R1 to 10RN are provided between them. For example, the transmitters 10S1 to 10SM (source nodes) transfer the data packet in M (orthogonal) resource blocks (time and/or frequency blocks). The N relay nodes 10R1 to 10RN forward this information to 10E (solid lines). For example, each relay node needs M orthogonal resources to transmit its transmission vector bRi, which is a vector of the length M. In contrast to the direct connection (dotted line), this process represents an indirect (cooperative) transmission of the data stream from 10S1 to 10E. The resulting data stream is illustrated in FIG. 2b. As can be seen, the resource demand for forwarding (cf. transmission vector b_{R}_{_{N}}) is significantly increased compared to the initial transmission Sₙ=>C (C=all potential receivers, 10e and/or relay nodes 10R1 to 10RN), or direct transmission (dotted line). The background for this is that each relay node 10R1 to 10RN individually forwards all data packets. The use of network coding (NC or NCC) in forwarding by means of the intermediate nodes 10R1 to 10RN improves the situation, as is shown on the basis of FIG. 3.

In turn, FIG. 3a shows the situation between the data sources 10S1 to 10SM in communication with the data sinks 10E by using the relays 10R1 to 10RN. For example, the relay nodes 10R1 to 10RN carry out NC or NCC and transmit in N resource blocks to forward the data packet to the receiver 10E (sink). The transmission vectors bR1, bR2 and bRN (cf. FIG. 2b) are compressed (cf. bR1, bR2, bRN in FIG. 3b) significantly by the network coded cooperation NCC, wherein the transmission vectors bR1 are still generated from the information signals transmitted by source nodes.

When the possibilities on one link are exhausted via channel coding, CC and particularly NCC have great potential, since the so-called diversity order (number of propagation paths) of the overall system is increased.

Since each received packet is forwarded in CC, the channel occupancy strongly increases. This can be avoided through NCC, since the forwarded packets are combined in this case. Thus, the channel occupancy does not grow. However, signalization as to which packets are included in the combined packet is now required.

This NCC signalization effort is a problem to be solved for radio networks with low deterministic latency.

In the conventional technology, there are a few approaches to solve the described problem as well. NCC describes methods in which data packets are combined and coded through a router prior to forwarding. In this case, several data packets (number n) are each weighted with coefficients (so-called coding coefficients) and are added. To this end, algebra in finite fields is used, and multiplication/addition in Galois fields with a size/symbol length of g bits is employed.

Subsequently, the conventional technology is analyzed, wherein the analysis results, i.e. the recognition of the problems in the conventional technology, are part of the teaching claimed herein since recognizing the problems and their causes represents the basis of the invention. In particular, the analysis of the causes could include indications as to the claimed solution and is therefore to be considered separately from the reflection of the conventional technology.

FIG. 4 illustrates an exemplary calculation of a coded packet on the basis of two source packets (source data packet 1, source data packet 2). Each source data packet is multiplied with a corresponding coding coefficient C1 and C2, respectively, and is added (XOR operation). The concatenation of the coding coefficient C1 and C2 is called coding vector n*g (size: 2*g bits).

For a receiver to be able to decode the packet, information—relevant information—e.g. about the source packets, coded packets, their respective coding coefficients included and/or the structure of the payload in general, is known. Coding coefficients are usually summarized to a so-called coding vector.

The amount of data g of a coding coefficient in bits depends on the size/dimension of the Galois field used. Thus, 2^{g} coding coefficients result for Galois fields with a characteristic 2. For the minimum amount of data of g=1, a coding coefficient may adopt the value 0 or 1.

If it is unknown which source packets are included and between which RNs they are to be transmitted, additional header information has to be transmitted. It includes two logical addresses that determine the data source and the data sink, as well as a coding coefficient per source packet, wherein a logical address may be described by a so-called node identity (node ID/NID). To this end, each radio node has a unique NID (allocation of the NID is not discussed herein).

Thus is shown further in FIG. 5, with a full header. The example of FIG. 5 also starts with the assumption that the source data packet DATA1 is to be multiplied with the coding coefficient C1 and the source data packet DATA2 is to be multiplied with the coding coefficient C2 so as to add them to the coded packet(s) (coded data). The coded packets (payload data packet) are part of a data packet 20 and are provided with the reference numeral 22. The header 24 is inserted in front of the coded packets. For example, it includes information with respect to data sources and data sinks (e.g. NID1 to NID2) and the associated coding coefficients (e.g. C1). This relevant information is provided with the reference numeral 24A and essentially defines the boundary conditions for transmitting DATA1 (source packet 1) from NID1 to NID2 (cf. reference numeral KOM1). In addition, the header 24 also comprises the area 24B in which the information (cf. reference numeral KOM2) with respect to the transmission of DATA2 (source packet 2) is transmitted. In turn, this includes the relevant information with respect to the data source NID1, data sink NID7 as well as the coding coefficient C2 used.

### Example 1: Any Combination Between Radio Nodes

Radio nodes have a short NID (7 bits) as a logical address. As a Galois field, GF(2⁴) with g=4 is selected. In addition, eight source packets are to be transmitted in one communication cycle. A generally applicable data packet could have the following form:

| | | | |
|---|---|---|---|
| source NID2 | destination NID1 | Coeff1 | header 24 |
| source NID3 | destination NID2 | Coeff2 | |
| source NID4 | destination NID3 | Coeff3 | |
| source NID5 | destination NID4 | Coeff4 | |
| source NID1 | destination NID5 | Coeff5 | |
| source NID2 | destination NID1 | Coeff6 | |
| source NID3 | destination NID2 | Coeff7 | |
| source NID4 | destination NID3 | Coeff8 | |

| | |
|---|---|
| payload coded data | payload 22 |

As can be seen, the payload coded data 22 includes data for presumably eight source packets to be transmitted, which becomes clear on the basis of the header 24. The header 24 includes, per source packet to be transmitted (per line), one information with respect to the data source, one information with respect to the data sink, as well as the corresponding coding coefficient.

The required NCC header length per coded source packet is 7 bits source NID+7 bits destination NID+Galois field with a size of 4 bits=18 bits. This results in an amount of data of 8*18 bits=18 bytes.

Radio nodes have a short NID (7 bits) as a logical address, 1 bit indicates whether the fixed radio node (base station) is an uplink or a downlink. As a Galois field, GF(2⁴) with g=4 is selected. In addition, eight source packets are to be transmitted in one communication cycle, e.g., this corresponds to a radio system in which a base station communicates with four field devices.

A generally applicable coded packet would then be (here, e.g., radio node 5 is the base station):

| | | | |
|---|---|---|---|
| NID1 | DL | Coeff1 | header 24 |
| NID2 | DL | Coeff2 | |
| NID3 | DL | Coeff3 | |
| NID4 | DL | Coeff4 | |
| NID1 | UL | Coeff5 | |
| NID2 | UL | Coeff6 | |
| NID3 | UL | Coeff7 | |
| NID4 | UL | Coeff8 | |

| | |
|---|---|
| payload coded data | payload 22 |

I.e., in each case, the header 24 comprises only one information with respect to the data source in combination with one information with respect to the data flow direction. The coding coefficients are still included per source packet to be transmitted.

The NCC header length per coded source packet would be:

7 bits NID+1 bit UL/DL+Galois field with a size of 4 bits=12 bits

This results in Len=N source packets*12 bits=8*12 bits=12 bytes.

In a transmission with a short latency, the amount of data to be transmitted per communication cycle is limited. Typical packet sizes are 30-255 bytes.

In this regard, a header overhead of 12, or 18, bytes would be a large proportion.

In the conventional technology, there are already some approaches that address the related problems. In this regard, international patent application WO 2014/134276 A1 is to be noted, which relates to a wireless network protocol and corresponding methods. A further conventional technology document is U.S. Pat. No. 964,780 B2, which concerns network coding. U.S. Pat. No. 10,270,468 B2 relates to a method for use in a distributed storage system. US 2018/0302836 describes a protocol for mesh networks. EP 3384619 A1 describes a method and an arrangement for performing extended network coding.

None of the above approaches offers the possibility to reduce, or to significantly reduce, the header length.

Embodiments of the present invention are based on the object to reduce the signalization effort in radio communication systems, in particular in radio communication systems that support real-time communication with low latency.

### SUMMARY

An embodiment may have a communication method, comprising: transmitting at least one data packet with a header and a coded packet into which one or several source packets are coded according to information of the header; wherein the header comprises, from a group, at least one first information relevant for interpreting the coded packet, wherein the group comprises one or several of the following information: —information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header: —a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header; and deriving, from the at least one first information under consideration of pre-configured information, one second information of the group that is relevant for interpreting the coded packet.

Another embodiment may have a non-transitory digital storage medium having a computer program stored thereon to perform the method, comprising: transmitting at least one data packet with a header and a coded packet into which one or several source packets are coded according to information of the header; wherein the header comprises, from a group, at least one first information relevant for interpreting the coded packet, wherein the group comprises one or several of the following information: —information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header: —a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header; and deriving, from the at least one first information under consideration of pre-configured information, one second information of the group that is relevant for interpreting the coded packet, when said computer program is run by a computer.

Another embodiment may have a data packet with a header and a coded packet into which one or several source packets are coded according to information of the header, wherein the header comprises, from a group, at least one first information relevant for interpreting the coded packet, wherein the group comprises one or several of the following information: —information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header: —a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header; wherein, from the at least one first information under consideration of pre-configured information, one second information of the group that is relevant for interpreting the coded packet is derivable.

Another embodiment may have a communication participant, in particular a transmitter and/or a receiver, configured to transmit at least one data packet with a header and a coded packet into which one or several source packets are coded according to an information of the header, wherein the header comprises, from a group, at least one first information relevant for interpreting the coded packet, wherein the group comprises one or several of the following information: —information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header: —a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header; and wherein the communication participant is configured to derive, from the at least one first information under consideration of pre-configured information, one second information of the group that is relevant for interpreting the coded packet.

Another embodiment may have a system with at least one inventive communication participant functioning as a transmitter and one inventive communication participant functioning as a receiver.

Embodiments of the present invention provide a communication method with the central step of transmitting, e.g. forwarding by means of a relay node, at least one data packet. The same comprises a header and a coded packet. According to embodiments, the coded packets may be used for transmissions of several source packets, e.g. between one or several sources and one or several sinks or between one source and one or several sinks in different transmission directions. In this case, e.g., one coding vector each is used for the source packets to be transmitted as a coded packet (e.g. one coding vector per coded packet). At least one relevant information, e.g. with respect to the coding vector, may be transmitted along in the header. The header includes (includes), in a derivable manner, from a group, at least one first information relevant for interpreting the coded packet, wherein the group includes one or several of the following information:
information with respect to one or several sources of the coded packet and information with respect to one or several sinks of the coded packet or information with respect to one or several sources (32) or sinks of the coded packet in combination with information with respect to a transmission direction;
a coding vector, wherein the coding vector is included separately, included integrally, pre-specified or referenced, wherein coding coefficients are allocated to the coding vector.

In addition, the transmission process includes deriving one second information of the group that is relevant for interpreting the coded packet from the at least one first information under consideration of pre-configured information.

Embodiments of the present invention are based on the finding that the signalization effort may be minimized by transmitting a coding vector that is either included in the header or referenced through other information, and information with respect to a data source and data sink that is directly included or referenced (i.e. that can be derived), in combination with pre-configured information, e.g. a coding matrix, scheduling table, or request list. Background for this is that by the relevant information included in the header, the further relevant information may be determined by using the pre-configured information (e.g. transmitted in advance). For example, a first minimization stage is possible in that coding coefficients or CV indexes (reference to a coding coefficient, or in the coding vector) are summarized as associated with one or several communication partners, or communication pairs, in a type of list (request list), so that not all of the coding information required for coding/decoding has to be transmitted in the header. Additionally or alternatively, coding coefficients, or coding vector(s), associated with communication processes and/or source packets may be included in a type of matrix (coding matrix), wherein this matrix is referenced by header information. Thus, for the source packets to be transmitted, each communication partner receives the required coding and/or decoding information, in particularly pre-configured information, wherein the extent of the header is minimized through referencing.

Thus, according to advantageous embodiments, pre-configured configurations, such as a coding matrix, a scheduling table, or a request list may be used to compress the information content in the header. According to embodiments, for example, the coding matrix may include a connection between the coding vector or coding vector index, both allowing a conclusion to be drawn as to the coding coefficients, and numberings of the source packet to be transmitted. Alternatively or additionally, according to further embodiments, a so-called scheduling table may be used. For example, the same specifies, from the perspective of the transmitting radio node (source), a data sink depending on a communication process number. Alternatively or additionally, according to embodiments, a so-called request list specifying coding vector indexes, e.g. on the basis of a transmission node (data source), for different data sinks and/or different communication partners in connection with a corresponding data flow direction, may be used. Alternatively or additionally, this request list may also specify an allocation to a corresponding cluster ID.

That is, according to an embodiment, the base embodiment is extended so that information that is typically transmitted in the header is now transmitted in a derivable way only, i.e. by referencing to pre-configured information, such as a scheduling table, a request list, or a coding matrix. In other words, e.g., the information with respect to the source and sink and/or the information with respect to the coding vector is not only included directly in the header, but also indirectly. Through this, in the minimum case, it is possible to operate with one bit per payload part (source data packet).

According to embodiments, the communication method may comprise the step of deriving information of the header from other information of the header or deriving information of the header from other information of the header under consideration of a scheduling table and/or a coding matrix and/or a request list.

According to embodiments, each of the several source data packets to be transmitted may have allocated thereto exactly one coding coefficient per communication process (CP). According to further embodiments, if one assumes that transmitting is carried out starting from a fixed communication partner (e.g. a fixed base station or source), additional information with respect to a source may be omitted in the header. That is, the header only comprises information with respect to one or several sinks of the payload (coded packet), possibly together with a transmission direction.

According to embodiments, the above-described request list is used for deriving further information as follows: the request list comprises information with respect to the one or several sources and/or sinks for one or several source packets. For example, the request list may comprise an allocation of one or several sources and/or one or several sinks to a corresponding coding vector index.

According to embodiments, the data packet comprises CV indexes for at least two transmissions including an uplink transmission and a downlink transmission or at least two scheduled transmissions between different communication partners. These CV indexes may then be included in the request list accordingly with a sequential numbering. According to embodiments, communication processes for several data packets are carried out in a temporal sequence. I.e., the step of transmitting, or the steps of transmitting and deriving (in combination), is/are repeated for one or several (continuously numbered) communication processes and/or are repeated in a temporal sequence (TDMA) and may therefore be (continuously) numbered. According to embodiments, this temporal sequence may be specified in a so-called scheduling table. According to embodiments, the scheduling table includes an allocation of communication processes to respective sources and/or respective sinks. For example, the temporal sequence of the communication processes, or the scheduling table, may have a fixed allocation of time slots to the one or the several respective data sources (and/or the respective data sinks). Alternatively, a fixed communication partner and one or several associated sources or sinks may be specified per communication process. Here, an indication with respect to the transmission direction would be conceivable.

With respect to the coding vector, or the desired (e.g. scheduled and/or expected) coding vector, according to embodiments, it is to be noted that the same may depend on, or be derivable from, a (continuous) numbering of the communication processes. For example, this connection, or the connection between the communication process (CP) and coding coefficient for a source packet in general, may be stored in a so-called coding matrix. According to embodiments, the coding matrix specifies a connection between the communication process and coding coefficients for a source packet. Alternatively, a fixed allocation of a respective fixed coding coefficient to a respective communication process and a coding vector index is defined in the coding matrix, wherein, as information, the header includes information of the coding vector (CV) as to whether a source packet (allocated to a coding vector index) is included in the data packet (20) (cf. extension 1 below). In other words, the coding vectors are specified per pair of data source—data sink or per data source and/or per data sink in general, possibly in combination with the transmission direction.

According to further embodiments, instead of the coding vector with coding coefficients, a coding vector index, i.e. e.g. a line index (reference to a desired coding vector), may be provided in the header and/or in a coding matrix. For example, this coding vector index is specified per communication process, or is directly derivable from the respective communication process, wherein a desired coding vector is derivable from this coding vector index by using the coding matrix (e.g. if the request list and/or scheduling list and/or coding matrix is known). In this case, a so-called compressed (compressed in lossless manner) coded data packet is created.

According to further embodiments, the header only comprises information with respect to one source per source packet to be transmitted. For example, this makes it possible that the sink can be derived from the information with respect to the source if, e.g., the request list and/or the scheduling table and/or the coding matrix is used. According to embodiments, the scheduling table comprises an indication with respect to a sink.

According to further embodiments, clustering several requests between several sources and several sinks or between one source and one sink in different transmission directions is conceivable. The different clusters may be indicated in the request list and therefore enable individual pairs of source/sink to specify the type of involvement of these nodes in a communication process so as to advantageously reduce the CV length, since, e.g., the same CV may be reused for different clusters. I.e., the request list is supplemented by an allocation according to which a cluster is allocated to each request.

According to embodiments, prior to transmitting the at least one data packet, an exchange, or distribution, of pre-configured information, such as a scheduling table and/or a coding matrix and/or a request list takes place between the communication partners. According to embodiments, a configuration of the transmitter and/or receiver may be carried out on the basis of the scheduling table and/or coding matrix and/or request list. This is advantageous since the information in the header is reduced and all of them access the same pre-configured data.

When reducing the above-described communication method to the transmission or forwarding process, transmission is performed by a transmitter or when transmitting/forwarding. According to embodiments, transmitting may include the sub-step of coding the payload by using a coding vector and/or generating the header. According to further embodiments, the following sub-steps are also included:
reading-out, from a coding matrix, a coding vector specified (scheduled) for the current communication process;
verifying and/or adapting coding coefficients associated with the coding vector (here, adapting means that a coding vector read out is adapted accordingly if not all of the source packets can be transmitted—as scheduled: for example, CV 345 is set as 305 if the second data packet (data packet for the second coding coefficient) cannot be transmitted; for example, when a coefficient is unequal 0, availability of the source packet is verified; if not available, a coefficient is set to =0 in the header;
coding a source packet by using the coding coefficients;
generating the header under consideration of the coding vector;
combining the header and the payload/coded packet(s) to a data packet.

According to further embodiments, if the communication method is now reduced to receiving, this may be part of receiving or may be performed by a receiver. In this case, e.g., the communication method comprises the following steps:
reading-out, from a coding matrix, the coding vector defined (expected) for the current communication process;
decoding the payload by using the coding vector;
according to an embodiment, for example, each communication partner verifies after the configuration whether it is part of the communication process.

Obviously, the method may also be computer-implemented so that the individual steps are induced by software.

A further embodiment relates to a data packet with a header, wherein the header includes, in a derivable manner (e.g. by reference to information exchanged in advance), the above-described information relevant for interpreting.

A further embodiment relates to a communication partner, in particular a transmitter or relay, or in particular to a receiver.

The communication partner is configured to transmit at least one data packet with a header and a payload/coded packet(s), wherein the header comprises the following information in a derivable way:
information with respect to one or several sources of the payload and information with respect to one or several sinks of the payload or information with respect to one or several sources or sinks of the payload in combination with information with respect to a transmission direction;
a coding vector, wherein a coding vector is included separately, included integrally, or specified; wherein the coding vector has allocated thereto coding coefficients.

The communication partner is configured to derive information of the header from other information of the header under consideration of pre-configured information.

Obviously, communication participants may also be a transmitter and a receiver at the same time. That is, each communication participant comprises a transceiver with one receiver and one transmitter. For example, UEs or ioT devices or the like are used as communication participants.

A further embodiment concerns a communication system with at least one communication participant that functions as a transmitter, and one communication participant that functions as a receiver. Obviously, the communication system may also include a plurality of communication participants.

According to embodiments, the developed method may be used for deterministic communication systems with low latency, i.e. the communication between the nodes is carried out within one communication cycle.

According to further embodiments, the radio nodes communicate directly with each other, i.e. they are located in radio range with respect to each other. This makes it possible for the so-called overhearing effect to be used. In this case, radio nodes may also receive data packets that do not belong to them, but to other radio nodes, and forward them.

According to embodiments, the number of participants and the amount of data per communication cycle exchanged between the radio nodes are configurable and adjustable at runtime. A spontaneous, quick change in the time domain of the communication cycle is not necessarily provided.

According to embodiments, the method includes, in transmitting at least one data packet (20), forwarding a source packet from a source (further node), or forwarding several source packets from several sources (further nodes). For example, forwarding is carried out by a repeater node. Alternatively, it may include forwarding a received data packet from a source, or forwarding several received data packets from several sources. Here, recoding is carried out, i.e. forwarding includes coding by using a further coding vector (e.g. which is different compared to the data packet(s) received).

### BRIEF DESCRIPTION OF THE DRAWINGS

Embodiments of the present invention will be detailed subsequently referring to the appended drawings, in which:

FIG. 1 shows a schematic radio system to illustrate the field of application;

FIGS. 2a and 2b show a schematic diagram to illustrate cooperative communication;

FIGS. 3a and 3b show a schematic diagram to illustrate cooperative communication by using network coding;

FIG. 4 shows a schematic diagram to explain a calculation in network coding;

FIG. 5 shows a schematic diagram to explain the contents of a header in network coding;

FIG. 6a shows a schematic illustration of a communication system to explain a base embodiment;

FIG. 6b shows an instrumental illustration of a header according to a base embodiment;

FIG. 7a-7i show schematic illustrations to explain the interconnection between a request list, a scheduling table, and a coding matrix to code, or decode, a transmission matrix according to embodiments;

FIG. 8 shows a schematic diagram to illustrate a process within a radio node at the start of a communication cycle according to an extended embodiment;

FIG. 9 shows a schematic block circuit diagram to illustrate processes within a radio node at the start of a communication process according to a further embodiment;

FIG. 10 shows a schematic block circuit diagram to illustrate processes within a radio node in the transmission case according to an extended embodiment;

FIG. 11 shows a schematic block circuit diagram to illustrate processes within a radio node in the reception case according to further embodiments; and

FIG. 12 shows a schematic block diagram to illustrate processes within a radio node at the end of a communication cycle according to an extended embodiment.

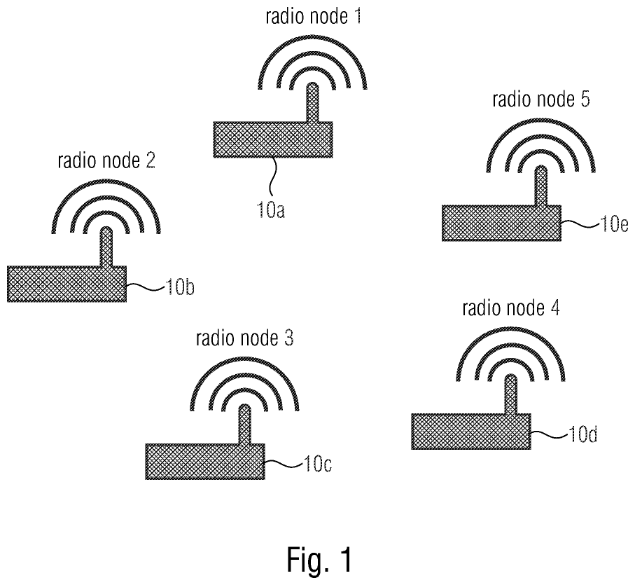

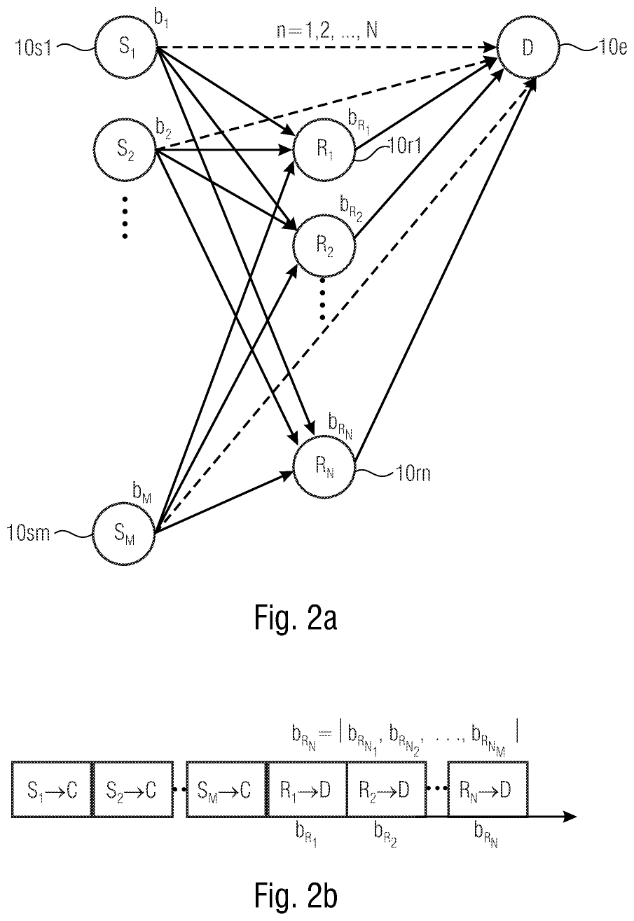

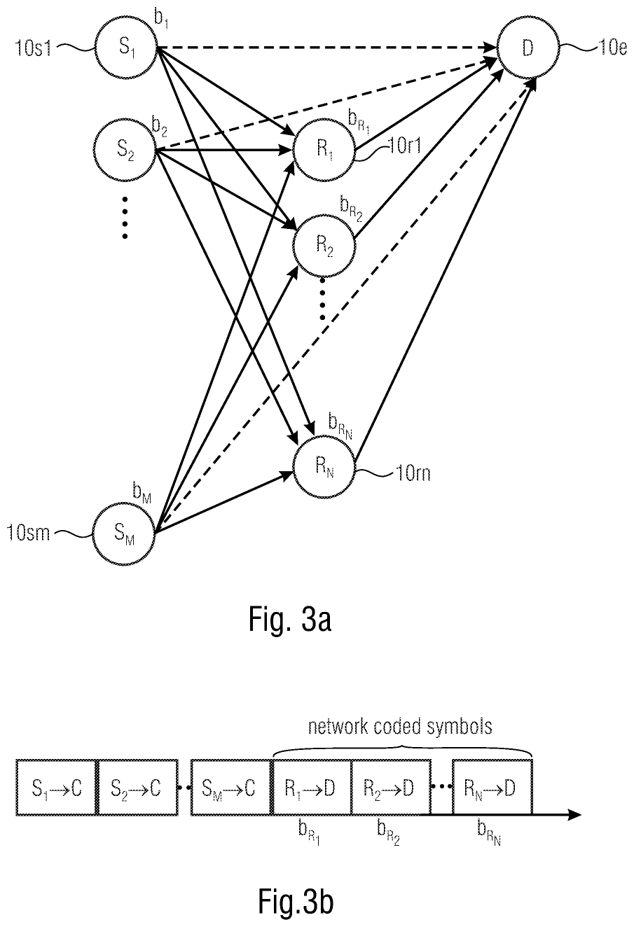

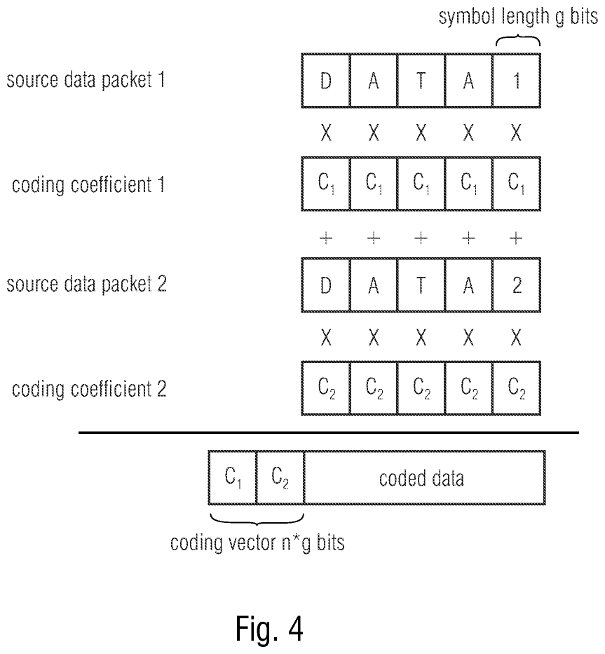

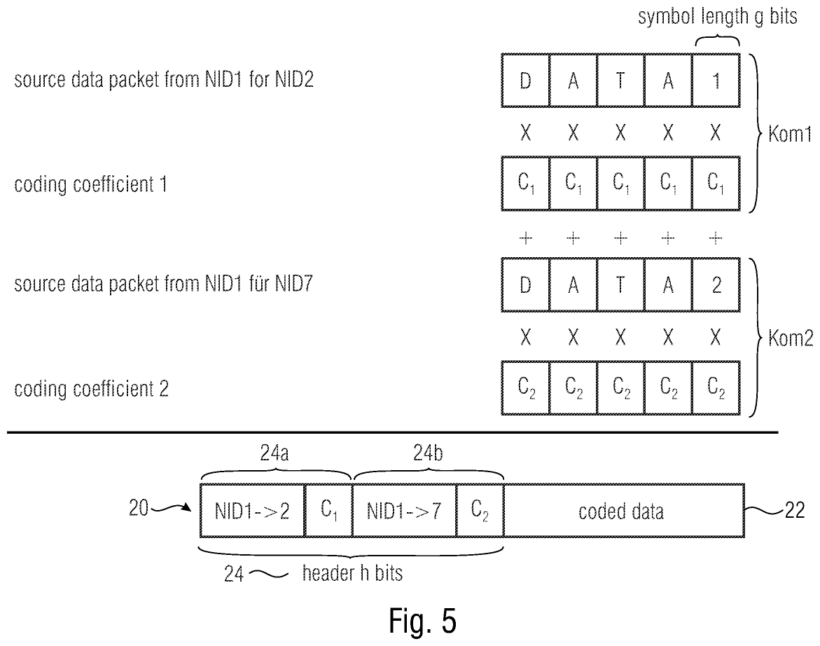

### DETAILED DESCRIPTION OF THE INVENTION

Before embodiments of the present invention are subsequently described on the basis of the accompanying drawings, it is to be noted that elements and structures having the same effect are provided with the same reference numeral so that their description can be applied to each other, or is interchangeable.

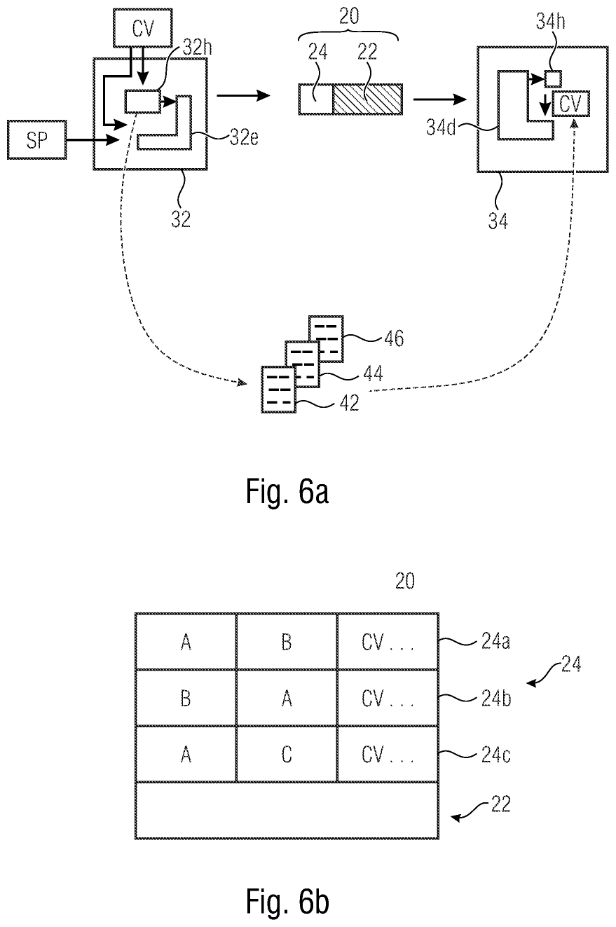

FIG. 6a shows a communication network 30 with a transmitter 32 and a receiver 34. The transmitter 32 transmits the coded data packet 20 to the receiver 34.

The transmitter 32 includes a header generator 32H as well as a network coding encoder 32e. The network encoder 32e is configured to decode a source packet SP by using coding coefficients so as to obtain a coded data packet. In coding, two or more source data packets SP may be convoluted with each other so that the two or more packets combined in the coded packet may be transmitted in a mutual resource. Separation of the several packets is carried out on the side of the receiver 34 by using the coding vectors CV used. This approach makes it possible to forward several data packets (e.g. from several sources) to several sinks with only “one” resource.

The coding coefficients are obtained by the receiver 34, e.g. via the coding vector CV. This coding vector CV is also integrated into the header. The integration process of the CV into the header 24 is carried out by the header generator 32H. This header 24 is part of the data packet 20 emitted by the encoder 32e. In addition to the header 24H, the data packet 20 includes the coded data packet(s) (cf. payload 22). At this point, it is to be noted that the encoder 32 includes several units, such as an actual decoder for the coded data packets 22, as well as a packer that combines the decoded data packets 22 and the header 24 to the data packet 20. At this point, it is to be noted that the coded data packets 22 may include several source packets to be transmitted. For example, an uplink from 32 to 34 as well as a downlink from 34 to 32 may be scheduled. Also, several source packets to be transmitted may be integrated in the same data packet for more than the two communication partners 32 and 34 illustrated. For example, the transmitter 32 may transmit a coded data packet to the receiver 34, wherein a further coded data packet for a further receiver (not illustrated) is included together with the same coded data packet 22.

The receiver 34 receives the data packet 20 and codes the data packet 20 by using the decoder 34d. To this end, the encoder typically uses the coding vector, or the coding coefficients derived from the coding vector. It obtains them with the help of the header. To this end, the receiver 34 comprises a header decoder 34H that extracts the relevant coding vector CV from the header 24 and provides it to the decoder 34d.

At this point, it is to be noted that the information in the header is transmitted in a reduced way, as is shown on the basis of FIG. 6b. For example, the header includes less information than actually required for the transmission. According to a variation, information with respect to the one or several data sinks (receivers) may be present in the header. Optionally, information with respect to the one or several data receivers may be present. According to an embodiment, the coding coefficients are not transmitted in the header, but a coding vector only. The coding coefficients can then be determined from the same, as will be explained subsequently. According to a variation, only CV indexes referenced in an additional data packet, e.g. information transmitted in advance, or pre-configured information, are included. The full information required for coding/decoding can be derived by using the pre-configured information, such as the request list 42, coding matrix 44, and/or scheduling table 46.

That is why, according to embodiments, the method may comprise the step of exchanging pre-configured information in advance. Furthermore, the method includes the step of deriving further information from information taken from the header by using the pre-configured information.

That is, according to a further embodiment, the header generator 32H and the header decoder 34H are used for generating and unpacking the header 22 and/or the header encoder 34e is used for encoding the pre-configured information. For example, this includes the elements request list 42, coding matrix 44, and/or scheduling table 46, indicated as being optional. These pre-configurations 42, 44, and 46 may be transmitted from the transmitter 32 to the receiver 34 in advance. The decoder 32D may also use information derived from the pre-configured information, i.e. the actual coding vector.

As shown with respect to FIG. 6b, the data packet 20 comprises a header 34. For example, this header 24 may include information for three source packets to be transmitted. They are marked with the reference numerals 24A, 24B, and 24C. In the payload/the coded data packets, all payload data is illustrated for the three source packets to be transmitted. In the area associated with the source packet 24A, a data source A, a data sink B, and the corresponding communication vector are illustrated. For the source packet 24B to be transmitted, a data source B, a data sink A, and the corresponding coding vector are included. As can be seen, 24A may define an uplink process, whereas 24B may define a downlink process. At 24C, e.g., another data sink C may be provided. For each of these source packets to be transmitted, defined via data source and data sink, a respective coding vector is allocated. By using the coding vector, the signalization effort may be reduced since the corresponding coding coefficients no longer have to be transmitted. They are derived from the coding vector.

According to a further embodiment, instead of A B, or B A, information with respect to the sink B may be included in the header parts for the first two source packets to be transmitted, and furthermore, information that the source packet to be transmitted is an uplink process and the other source packet to be transmitted is a downlink process may be included. In this case, this is based on the assumption that the header is written from the perspective of the communication partner A. In this case, the data transfer C would be defined by information “uplink” and data sink C. According to further embodiments, it would also be conceivable that no information about the coding vector is included, but that the coding vector may be derived from a coding matrix, for example, wherein the coding matrix includes information with respect to the used coding vectors associated with the communication processes (numbered communication processes) or associated with the communication partners (e.g. data sink). At this point it is to be noted that, e.g., the CV indexes and/or requests may be allocated to the columns of the coding matrix and the PCs may be allocated to the lines.

Through these further measures, the content of the header may be reduced further. This approach is subsequently described in detail, wherein, at this point, it is already to be noted that any combinations of pre-configured information and transmitted information are possible. All processes have in common that the header includes less information as actually required for coding/transmission, wherein the missing information is derived from other information blocks of the header or derived by using pre-configured information.

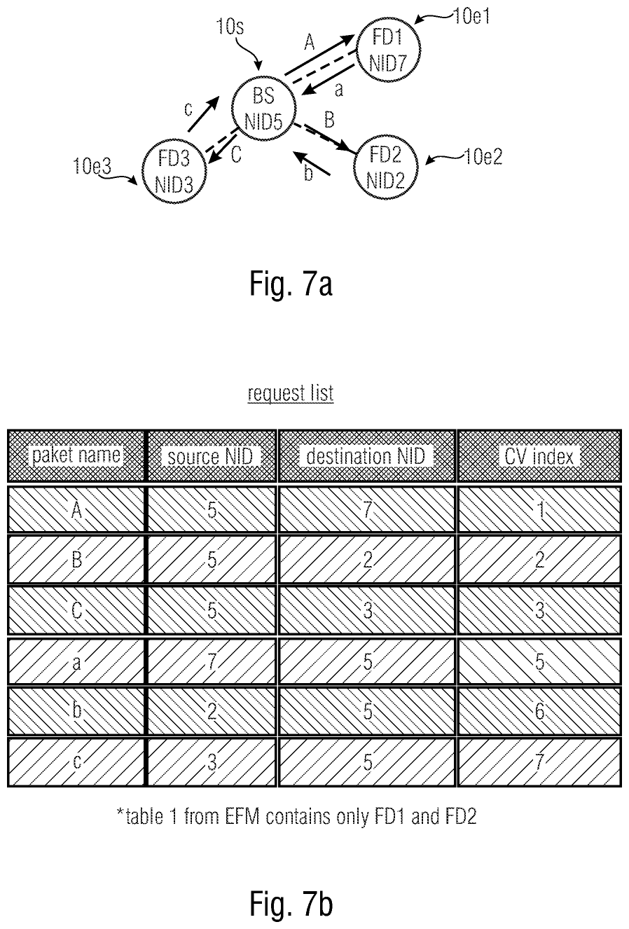

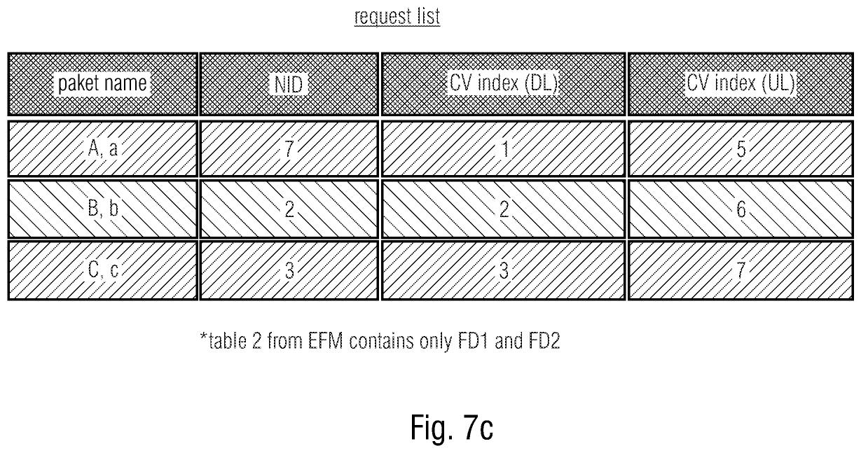

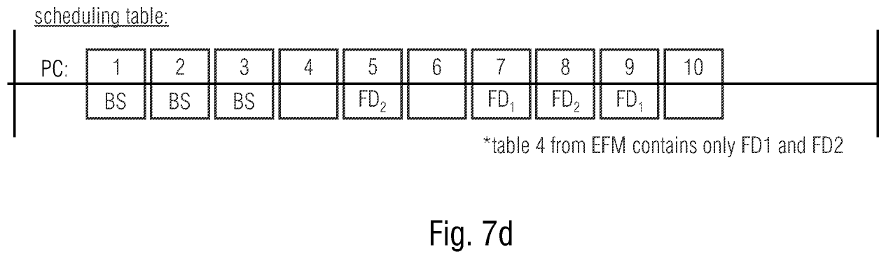

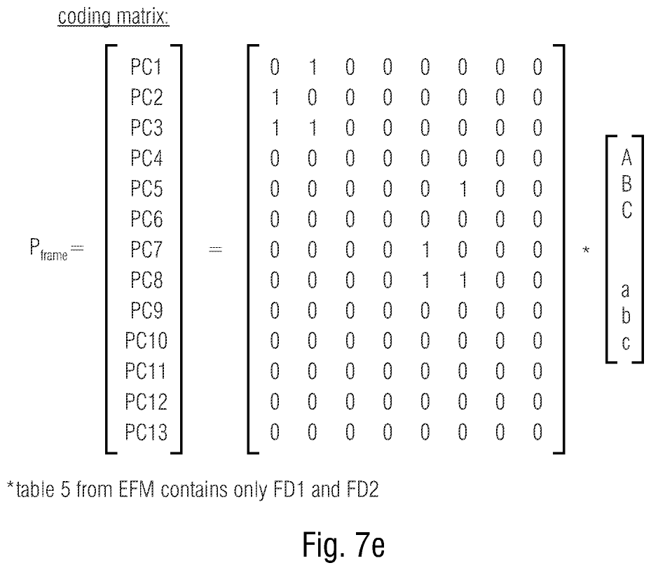

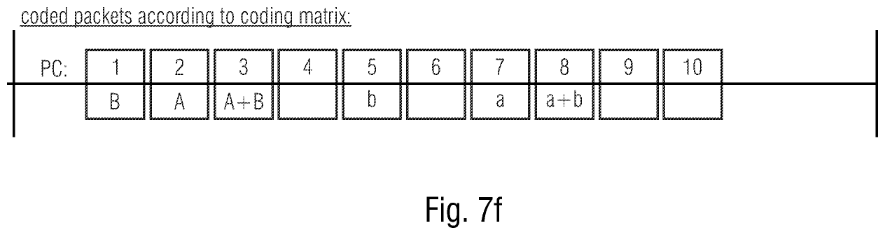

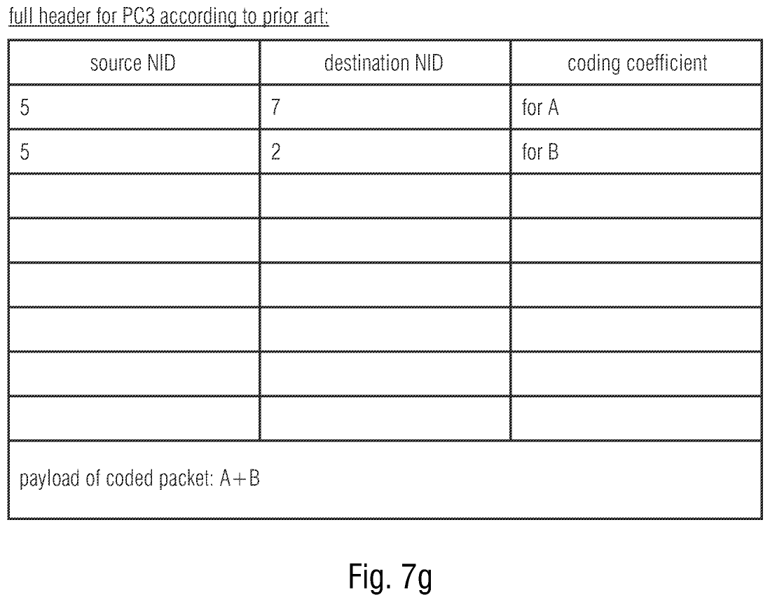

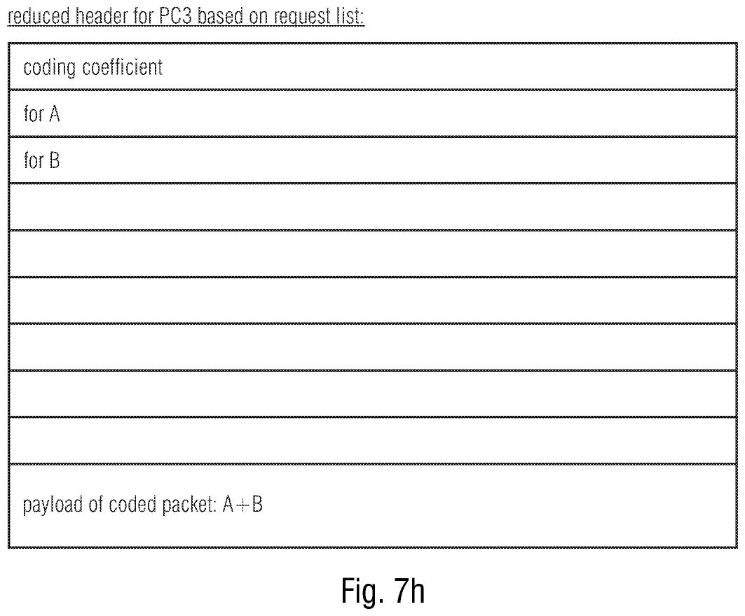

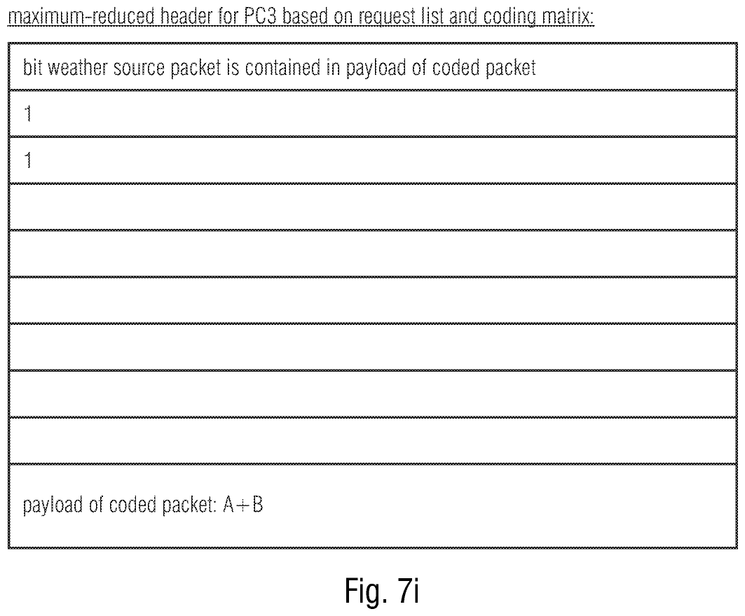

FIG. 7a shows the communication connection between a base station 10S and three nodes 10E1-10E3. The base station 10S has the NID 5, the receivers 10E1-10E3 are numbered with NIDs 7, 2, and 3. The communication connection between the respective elements is marked with the letters A, B, and C for the downlink and a, b, and c for the uplink.

The subsequent discussion assumes that all six potential transmissions A, B, C, a, b and c are requested (cf. request). These requests are adopted in a request list, as is illustrated in FIG. 7b. Here, this request list of FIG. 7b includes all transmissions associated with the source and the sink (source NID and destination NID) marked in FIG. 7a. Furthermore, in this request list, coding vectors CV, here shown on the basis of coding vector in the indexes, are allocated to the transmissions A, B, C, a, b, c. At this point, it is to be noted that a coding vector index illustrates a referencing in a corresponding coding vector. The coding vector indexes are numbered from 1 to 7 according to their order in the request list. According to a variation, the request list may also be illustrated in a compressed way, as is shown in connection with FIG. 7c.

In the further development of FIG. 7c, it is assumed that a communication with the base station 10S is currently carried out. In this case, it is sufficient if only the other communication node is indicated as NID, and that the corresponding CV index is referenced according to uplink or downlink (cf. A, B and C, or a, b and c).

The list illustrated in FIG. 7c is valid for a communication process, i.e. for a time slot. According to embodiments, several communication processes may be carried out in subsequent time slots. They are exemplarily illustrated in the scheduling table of FIG. 7d. It exemplarily illustrates that the base station transmits in the first three communication processes, whereas the communication from the perspective of one of the nodes 10E1-10E3 is considered in the communication processes 7, 8, and 9. Via this multitude of temporally subsequent communication processes, the corresponding coding vector or a coding vector index may be considered, e.g., referenced in the coding matrix. The coding matrix is shown in FIG. 7e.

Via the individual communication processes CP1-CP13, the coding matrix illustrates the respective value for the corresponding transmission process A, B, C, a, b, c. For example, a downlink transmission B is carried out in the communication process CP1, whereas a downlink transmission A is performed in the communication process CP2 (cf. FIG. 7a). The result is shown in FIG. 7f, illustrating the coded packet according to a decoding matrix across the corresponding communication processes 1-10. Considering this coding matrix, one header per communication process may be determined, overall comprising a reduced content.

The full header to be typically transmitted for the communication process CP3 is illustrated in FIG. 7g. In the communication process CP3, the communication A and B are enabled (cf. FIG. 7e, or 7f), that is from the perspective of the base station (cf. scheduling table from FIG. 7d). In this respect, the source NID is 5 in each case, and the destination NID is 7, and 2. The corresponding coding coefficients for A and B are 1, as results from FIG. 7e. According to embodiments, this full header of FIG. 7g may be reduced by the use of a pre-configured information request list, scheduling list, and/or coding matrix, as is exemplarily shown in FIG. 7h.

FIG. 7h shows a reduced header into which, starting from the list request list of FIG. 7b, the coding coefficients or CV indexes are inserted. In this respect, according to a first compression stage, the header may be reduced by using the request list so that neither source nor sink have to be included in the same. A further reduction is possible, as is shown with respect to FIG. 7i.

FIG. 7i uses the coding matrix in addition to the request list, so that only one bit has to be used to indicate whether a corresponding data packet is included or not.

As described above, the pre-configured information includes, e.g. the request-list, a scheduling table, and/or a coding matrix. Subsequently, examples for such pre-configured information are described in detail.

Request List

A request refers to a source data packet that is to be transmitted from a radio node as a data source to a radio node as a data sink (destination). Source/destination is described via their node identity. Several data packets between the same source/destination radio node are handled as several requests. From this, a request list with request indexes may be generated. At this point, it is to be noted that the request is typically defined on the application level.

An index in the coding vector (CV) is unambiguously allocated to each request. The coding coefficient is inserted at the location described by the CV index.

### Embodiment: Request List 1, any Communication Between Radio Nodes

the coding coefficient C_{NID5->NID2} for a data packet from the source NID5 to the sink NID2 is signaled under CV index 2
the coding coefficient C_{NID2->NID5} for a data packet from the source NID2 to the sink NID5 is signaled under CV index 6

| source | destination | CV |
|---|---|---|
| NID | NID | index |
| 5 | 2 | 2 |
| 2 | 5 | 6 |
| 5 | 7 | 1 |
| 7 | 5 | 5 |

Table 1: Request List with Arbitrary Radio Nodes as Source/Destination

### Embodiment: Request List 2, Communication Between a Fixed Radio Node as a Base Station and Further Radio Nodes

If the request takes place between a fixed radio node (base station BS) and radio nodes only (there is no communication of radio nodes to radio nodes), Src/Dest may also be called UL/DL.

| | CV index | CV index |
|---|---|---|
| NID | for DL | for UL |
| 2 | 2 | 6 |
| 7 | 1 | 5 |

Table 2: Request List with One Fixed Radio Node as a Base Station and Further Radio Nodes

According to embodiments, the CV index may also be derived directly from the NID. This method can used if the number of participating nodes is small and the NID is assigned in a consecutively numbered way in the network so that all positions in the CV are occupied.

### Embodiment: Request List 3, Request List in which the Index in the Coding Vector CV is Determined by the NID (CV Index=NID*2-1 for Uplink, CV Index=NID*2 for Downlink)

| CV | |
|---|---|
| Index | NID |
| 1 | 1 uplink |
| 2 | 1 downlink |
| 3 | 2 uplink |
| 4 | 2 downlink |
| 5 | |
| 6 | |
| 7 | |
| 8 | |

Table 3: Request List with One Fixed Radio Node as a Base Station and Further Radio Nodes and a Link Between NID and CV Index.

The above-stated request lists have in common that a coding vector is indicated and referenced for a communication partner pair, e.g. defined via a sink in combination with a flow direction or for a data source in combination with a data sink.

Scheduling List

The scheduling table describes the temporal sequence of communication processes (PC) within a finite time frame and specifies the type of the participation of the individual RN in the respective PC. The PCs are numbered consecutively (1, 2, . . . , np c), wherein n_{PC} indicates the overall number of all PCs in the scheduling table. An allocation between transmission slots and RN already available in a TDMA system may be adopted.

### Example

| | source |
|---|---|
| PC | NID |
| 1 | 5 |
| 2 | 5 |
| 3 | 5 |
| 4 | |
| 5 | 2 |
| 6 | |
| 7 | 7 |
| 8 | 2 |
| 9 | 7 |
| 10 | |
| . . . | |
| n_{PC} | |

Table 4: Scheduling Table with Indication of the Transmitting Radio Node

In other words, the scheduling list enables allocating communication processes in a temporal sequence. For example, the communication processes are identified on the basis of the data sources.

Coding Matrix

The coding matrix determines which source data packet is to be coded into the coded packet of a certain PC according to the request list.

| | CV | CV | CV | CV | CV | CV | CV | CV |
|---|---|---|---|---|---|---|---|---|
| | index | index | index | index | index | index | index | index |
| PC | 1 | 2 | 3 | 4 | 5 | 6 | 7 | 8 |
| 1 | | 1 | | | | | | |
| 2 | 1 | | | | | | | |
| 3 | 1 | 1 | | | | | | |
| 4 | | | | | | | | |
| 5 | | | | | | 1 | | |
| 6 | | | | | | | | |
| 7 | | | | | 1 | | | |
| 8 | | | | | 1 | 1 | | |
| 9 | | | | | | | | |
| 10 | | | | | | | | |
| . . . | | | | | | | | |
| n_{PC} | | | | | | | | |

Table 5: Coding Matrix

“1” indicates a coding coefficient different from zero, i.e. the information of the corresponding source packet is to be included in the coded packet. The coding coefficient actually used for weighting the source packet may be indicated in the coding matrix in case of systematic linear network coding (instead of “1”, with “1” to “2^{g}−1”, depending on the Galois field size). Alternatively, an arbitrary coding coefficient newly selected per PC may be used. With this, random linear network coding may be signaled efficiently. In this method, the coding coefficients are generated with a random process.

Advantageously, the three pre-configured pieces of information of coding matrix, scheduling table and request list are applied together, as will be described in the following.

For example, the following results for PC 3:
according to the scheduling table (table 4), radio node NID5/BS is transmitting
according to the coding matrix (table 5), source packets at CV index position 1 and CV index position 2 are to be coded into the coded packet
according to the request list (table 1/table 2), these are the packets from “NID5/BS to NID7” and “NID5/BS to NID2”

According to embodiments, using the three lists as a data basis in each node (data source, data sink, or relay), the coded packet may be transmitted in a compressed way. For example, the following compressed data packet results from this:

Coeff CV index 1
Coeff CV index 2
Coeff CV index 3
Coeff CV index 4
Coeff CV index 5
Coeff CV index 6
Coeff CV index 7
Coeff CV index 8
payload coded data

The NCC header length would then be the Coeff length (according to the Galois field dimensions), e.g. 4 bits.

For example, in case of one base station with four radio nodes, eight pieces of coefficient information are required: 32 bits packed=4 octets (instead of 12 octets of the general header).

According to further embodiments, the above-described exemplary concept may be extended, as will be described on the basis of the extended coding matrix. One assumes that a coding matrix with fixed coding coefficients is used for systematic linear network coding. They are indicated in the following table:

| | CV | CV | CV | CV | CV | CV | CV | CV |
|---|---|---|---|---|---|---|---|---|
| | index | index | index | index | index | index | index | index |
| PC | 1 | 2 | 3 | 4 | 5 | 6 | 7 | 8 |
| 1 | | Coeff₁₂ | | | | | | |
| 2 | Coeff₂₁ | | | | | | | |
| 3 | Coeff₃₁ | Coeff₃₂ | | | | | | |
| 4 | | | | | | | | |
| 5 | | | | | | Coeff₅₆ | | |
| 6 | | | | | | | | |
| 7 | | | | | Coeff₇₅ | | | |
| 8 | | | | | Coeff₈₅ | Coeff₈₆ | | |
| 9 | | | | | | | | |
| 10 | | | | | | | | |
| ... | | | | | | | | |
| n_{PC} | | | | | | | | |

“Coeffxy” means that for the PC x the source packet referenced at the location of the CV index y is to be weighted with this coding coefficient.

In the compressed coded packet, it has to be indicated whether the corresponding source packet is actually included, which corresponds to the logic information of 1 bit.

Coeff CV index 1 included
Coeff CV index 2 included
Coeff CV index 3 included
Coeff CV index 4 included
Coeff CV index 5 included
Coeff CV index 6 included
Coeff CV index 7 included
Coeff CV index 8 included
payload coded data

The NCC header length would then only be the number of coding coefficients in bits. For example, in case of one base station with four radio nodes, eight pieces of coefficient information are required: 8 bits packed=1 octet (instead of 12 octets of the general header).

According to further embodiments, an extension of the request list by means of clustering would be conceivable. If many radio nodes are present in the system, there are consequences for NCC:
the CV becomes long, which generates header overhead;
the processing duration for coding and decoding increases strongly.

In order to avoid this, clusters may be formed.

| source | destination | CV cluster | CV |
|---|---|---|---|
| NID | NID | (optional) | index |
| BS | 2 | 1 | 2 |
| 2 | BS | 1 | 6 |
| BS | 7 | 1 | 1 |
| 7 | BS | 1 | 6 |
| BS | 9 | 2 | 2 |
| 9 | BS | 2 | 6 |

The table of example 1 has been extended by clusters. This makes it possible that the CV indexes are assigned per cluster.

According to further embodiments, the scheduling table may be extended as well. The scheduling table may be extended with an indication of a destination NID. Through this, overhearing may be limited, e.g., so as to save energy.

### Example

| PC | source | destination |
|---|---|---|
| 0 | NID | NID |
| 1 | BS | 2 |
| 2 | BS | 7 |
| 3 | BS | broadcast |
| 4 | | |
| 5 | 2 | broadcast |
| 6 | | |
| 7 | 7 | broadcast |
| 8 | 2 | BS |
| 9 | 7 | BS |
| 10 | | |
| n_{PC} | | |

According to further embodiments, these extended elements of scheduling table, request list, and coding matrix can be used together or on their own in combination with the base variations.

In the following, the specific method according to the above-described teaching is described on the basis of a further example. In the method, there is a fundamental differentiation between a configuration phase and an operation phase.

Configuration Phase

To operate the communication system, all RNs of the communication system are configured on the basis of the configuration information, in particular on the basis of the request list, the scheduling table, and the coding matrix. According to embodiments, a configuration phase prior to the operation phase (initialization), or between operation phases in case of a change in the network topology (reconfiguration), may be provided. The radio communication between the nodes may be used for the configuration. Through this, each RN then obtains the corresponding configuration parameters (request list, scheduling table, and coding matrix).

Operation Phase

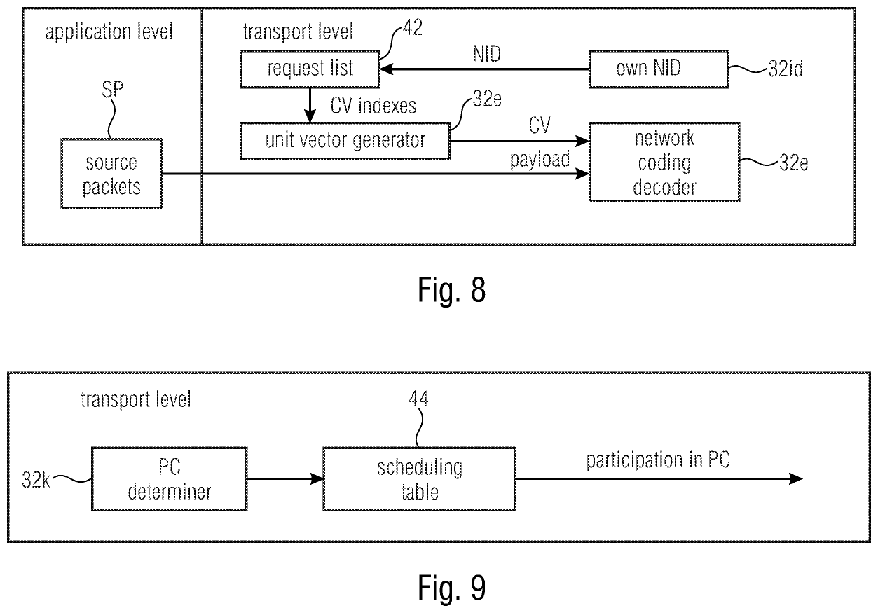

It is assumed that the communication is carried out in cycles. Within one cycle, there are several communication processes, wherein each RN internally determines the number of the PCs already completed within a cycle, e.g. through an internal timer or counter. At the start of a cycle, the state of the network coding encoder/decoder is reset so that they do not include any coded packets from previous communication cycles. Subsequently, each RN examines on the basis of its NID which source packets it is to emit according to the request list within this cycle. Each source packet to be emitted is supplied together with the i-th unit vector eᵢ as a CV into a network coding decoder, wherein i corresponds to the CV index of the request. This is exemplarily illustrated on the basis of FIG. 8.

FIG. 8 shows the units participating in the transmission process in a separated way according to an application level and a transport level. The network coding encoder 32e decodes from the packet SP in the transport level. To this end, the same obtains the coding vectors CV from the unit vector generator 32EV. Coding vector indexes from the request list may be used as input, wherein the own NID 32-ID is the input parameter for the request list 42. That is, the corresponding CV indexes are obtained from the request list with the on NID, wherein the unit vector generator 32E derives the coding vector. According to embodiments, the unit vector generator 32E may here be used for the coding matrix 46.

At the start of a PC, each RN verifies whether it is actively (transmitting) or passively (receiving) or is neither actively nor passively (only in the case of extension 2/3) participating in the PC according to the scheduling table (cf. FIG. 9).

FIG. 9 illustrates once more the transport level when using the scheduling table by the PC determiner 32.

This results in the following process with the steps 1 to 5 and the optional steps 4A and 4B.

In the case of an active participation, the following processes are carried out on an RN:
1. Reading-out, from the coding matrix, the CV desired (corresponds to expected or scheduled, depending on the perspective (perspective of the receiver: expected, perspective of the transmitter: scheduled, here in the sense of “planned”) for the current PC;
2. The network coding encoder verifies whether the RN knows the source packets associated with the CV indexes of the desired CV. For all CV indexes with associated known source packets, the coding coefficients of the actual and the desired CV match. For all CV indexes with associated unknown source packets, the value 0 is allocated to the coding coefficients of the actual CV (e.g. if a packet has not been received and can therefore also not be forwarded). If, for example, the transmission of three source packets with the CV 513 is scheduled, however, the second source packet cannot be received and therefore also not be forwarded, an actual CV of 503 results from the scheduled CV 513.
3. The network coding encoder computes the payload of a coded packet. Coding is carried out on the basis of the actual CV.
4. The header encoder forms a header from the actual CV.
   a. Without extension 1, the header and the actual CV are identical.
   b. With extension 1, the header and the compressed CV described in extension 1 are identical.

The packer forms a coded packet from the header and the payload.

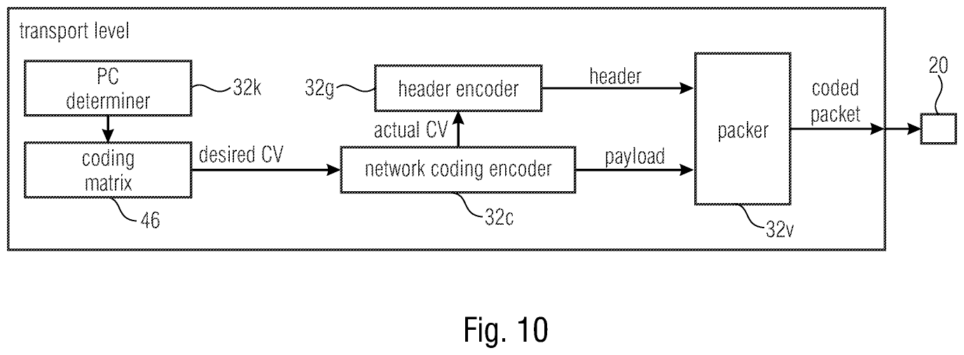

This process is fully illustrated in FIG. 10.

FIG. 10 shows another extension of the transport level with the network encoder 32E. In turn, the same maintains a coding vector, e.g. derived from the coding matrix 46, as an input vector, wherein the PC determiner 32K serves as an input parameter for the coding matrix. This encoder 32E then codes the payload accordingly and forwards it to the packer 32V. The same then combines the header of the header encoder or header generator 32G with the coded payload. As an input parameter for the header, the header encoder then obtains the coding vector used from the encoder 32E.

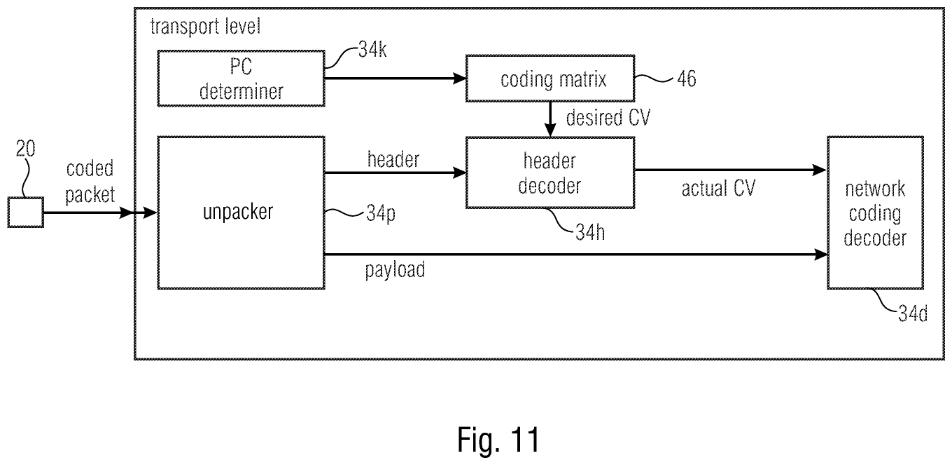

FIG. 11 shows the process of receiving the coded packet 20 (cf. output of the packer 32V), or the input (depacker 34P) connected to the decoder 34d.

On the transport level, the data packet 20 is unpacked in the reception part (cf. 34P), wherein the header and the payload/coded data packet are separately supplied to the decoders 34H and 34D. The header decoder extracts the coding vector serving as an input parameter for the network coding decoder 34D. The header decoder 34H uses as an input parameter the coding matrix 46 that in turn receives the communication process number as an input parameter from the PC determiner 34K.

This results in the following process with the four steps 1 to 4 and the optional steps 3A and 3B.

In case of passive participation, the following processes are carried out on an RN:
1. Reading-out, from the coding matrix, the CV desired (here in the sense of “expected”) for the actual PC.
2. Dividing a coded packet into a header and a payload.
3. The header decoder reconstructs the actual CV from the desired CV and the header.
   a. Without extension 1, the actual CV and the header are identical.
   b. With extension 1, the actual CV is computed by the element-per-element multiplication of the header and the desired CV.

The network coding decoder processes the actual CV together with the payload.

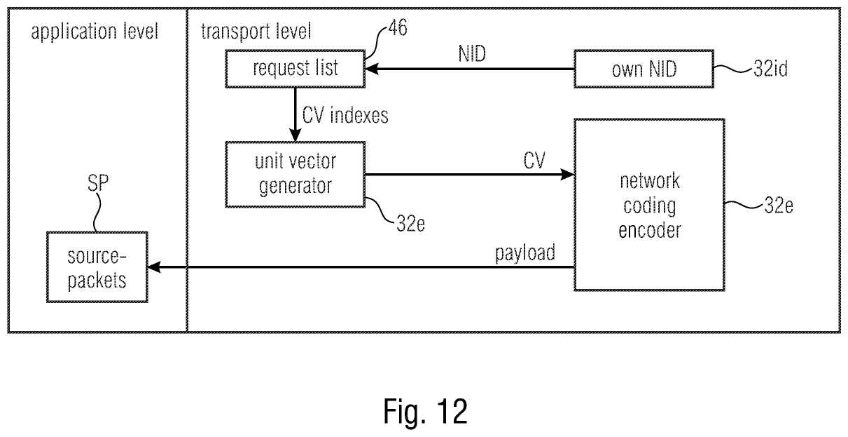

At the end of a communication cycle, according to embodiments, each RN verifies on the basis of the request list and its NID which source packets, or CV indexes, are determined for the same. For each of these CV indexes, an associated unit vector is formed, wherein a CV index i has associated therewith the i-th unit vector eᵢ. The unit vectors are sequentially fed into the network coding encoder (FIG. 12).

Thus, FIG. 12 shows the process within an RN at the end of a communication cycle. By means of the own ID 32-ID, the request list 46 obtains the NID so as to determine therefrom the CV index. The unit vector generator 32E determines the coding value on the basis of the CV index and provides it to the network coding encoder 32E. The same encodes therefrom the coded data packet to the source packet and forwards this source packet SP to the application level.

Each reconstructable source packet is transmitted to the application level. Non-reconstructable source packets remain in the network coding encoder and are deleted at the start of the next communication cycle.

The above approach is applicable for radio communication systems that operate deterministically so as to support real-time communication and to achieve at the same time a low latency.

For example, the scheduling table includes an allocation of communication participants/nodes to communication processes. For example, the coding matrix includes an allocation of source data packets to coded data packets and may include coding vectors for the individual communication processes. For example, the request list includes an allocation of CV indexes to communication participants/nodes.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

A signal encoded according to the invention, such as an audio signal or a video signal or a transport current signal, may be stored on a digital storage medium or may be transmitted on a transmission medium, such as a wireless transmission medium or a wired transmission medium, e.g. the internet.

The audio signal encoded according to the invention may be stored on a digital storage medium or may be transmitted on a transmission medium, such as a wireless transmission medium or a wired transmission medium, e.g. the internet.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile.

A further embodiment of the inventive method thus is a data stream or a sequence of signals representing the computer program for performing any of the methods described herein. The data stream or the sequence of signals may be configured, for example, to be transmitted via a data communication link, for example via the internet.

A further embodiment includes a processing unit, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

For example, the apparatuses described herein may be implemented using a hardware device, or using a computer, or using a combination of a hardware device and a computer.

The apparatuses described herein, or any components of the apparatuses described herein, may at least be partially implement in hardware and/or software (computer program).

For example, the methods described herein may be implemented using a hardware device, or using a computer, or using a combination of a hardware device and a computer.

The methods described herein, or any components of the methods described herein, may at least be partially implement by performed and/or software (computer program).

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Communication method, comprising:
transmitting at least one data packet with a header and a coded packet into which one or several source packets are coded according to information of the header;
wherein the header comprises, from a group, at least one first information relevant for interpreting the coded packet, wherein the group comprises one or several of the following information:
information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header:
a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header; and
deriving, from the at least one first information under consideration of pre-configured information, one second information of the group that is relevant for interpreting the coded packet.

2. Communication method according to claim 1, wherein the pre-configured information comprises a scheduling table and/or a coding matrix and/or a request list.

3. Communication method according to claim 1, wherein the data packet comprises the header for one or several source packets to be transmitted between one or several sources and several sinks or between one source and one or several sinks in different transmission directions, and the coded packet for the one or several source packets to be transmitted; and/or
wherein a coding vector is allocated to the coded packet; and/or
wherein the at least one data packet is used for at least two source packets to be transmitted, comprising an uplink transmission and a downlink transmission, or for at least two source packets to be transmitted between different communication partners.

4. Communication method according claim 1, wherein transmitting is carried out starting from a fixed communication partner, and/or wherein the header only comprises information with respect to one or several further communication partners for the coded packet together with a first transmission direction.

5. Communication method according to claim 2, wherein the request list comprises information with respect to the one or several sources and/or sinks for one or several source packets; and/or
wherein the request list comprises an allocation of the one or several sources and/or sinks to a corresponding coding vector or coding vector index referencing to a coding coefficient in the coding vector.

6. Communication method according to claim 1, wherein transmitting or transmitting and deriving is repeated for one or several communication processes or is performed repeatedly for one or several communication process in a temporal sequence; or wherein transmitting or transmitting and deriving is repeated for one or several communication processes or is performed repeatedly in a temporal sequence for one or several communication processes, wherein the temporal sequence is determined by a scheduling table.

7. Communication method according to claim 6, wherein the temporal sequence and/or the scheduling table comprises a fixed allocation of a time slot to the respective source(s) and/or the respective sink(s); and/or
wherein the scheduling table comprises an indication with respect to a fixed communication partner and an associated source or an associated sink per communication process.

8. Communication method according to claim 6, wherein the desired coding vector or a coding vector index referencing to a coding coefficient in the (desired) coding vector depends on and/or is derivable from a numbering or temporal sequence; or wherein the desired coding vector depends on or is derivable from a numbering or temporal sequence and the connection is comprised by a coding matrix; and/or
wherein a coding matrix defines a connection between a communication process and coding coefficients for a source packet; and/or
wherein a fixed allocation of a respective fixed coding coefficient to a respective communication process and a coding vector index is defined in the coding matrix.

9. Transmission method according to claim 8, wherein the header comprises one compressed version of the coding vector per communication process from which the coding vector is derivable per communication process; and/or
wherein, as information with respect to the coding vector, the header comprises information as to whether a source packet (allocated to a coding vector index) is comprised by the data packet.

10. Communication method according to claim 1, wherein the request list is supplemented by an allocation that allocates a cluster to each request.

11. Communication method according to claim 1, wherein, prior to transmitting the at least one data packet, a distribution of pre-configured information and/or a scheduling table and/or a coding matrix and/or a request list is carried out between the communication partners.

12. Communication method according to claim 11, wherein a configuration of the transmitter or the source and/or the receiver or the sink is carried out on the basis of the scheduling table and/or the coding matrix and/or the request list.

13. Communication method according to claim 11, wherein the exchanged scheduling table, coding matrix, and/or request list is valid for several communication processes.

14. Communication method according to claim 1, wherein the communication method comprises transmitting or forwarding or is performed by a transmitter or relay node, wherein transmitting or forwarding comprises coding the coded packet by using the coding vector and/or generating the header; and/or
wherein transmitting comprises:
reading out, from a coding matrix, a coding vector specified for the current communication process;
verifying and/or adapting coding coefficients allocated to the coding vector;
coding a source packet by using the coding coefficients;
generating the header under consideration of the coding vector,
combining the header and the coded packet to a data packet.

15. Communication method according to claim 1, wherein the communication method comprises receiving; or
wherein the communication method comprises receiving and receiving comprises:
reading out, from a coding matrix, the coding vector defined for the current communication process;
decoding the coded packet by using the coding vector and the received header.

16. Communication method according to claim 1, wherein each communication participant verifies whether it participates in a communication process comprising transmission on the basis of pre-configured information.

17. Communication method according to claim 1, wherein transmitting at least one data packet comprises forwarding a source packet from a source or forwarding several source packets from several sources; or
wherein transmitting at least one data packet comprises forwarding a received data packet from a source or forwarding several received data packets from several sources; and/or
wherein forwarding comprises coding by using a further coding vector.

18. Communication method according to claim 1, wherein, at the start of a communication process, a participating communication participant that performs the transmission only knows part of the data packets; and/or
wherein signaling the data packets to be transmitted or the data packets transmitted is done by transmitting information with respect to the presence and/or absence of individual data packets.

19. A non-transitory digital storage medium having a computer program stored thereon to perform the method, comprising:
transmitting at least one data packet with a header and a coded packet into which one or several source packets are coded according to information of the header;
wherein the header comprises, from a group, at least one first information relevant for interpreting the coded packet, wherein the group comprises one or several of the following information:
information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header:
a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header; and
deriving, from the at least one first information under consideration of pre-configured information, one second information of the group that is relevant for interpreting the coded packet,
when said computer program is run by a computer.

20. Data packet with a header and a coded packet into which one or several source packets are coded according to information of the header, wherein the header comprises, from a group, at least one first information relevant for interpreting the coded packet, wherein the group comprises one or several of the following information:
information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header:
a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header;
wherein, from the at least one first information under consideration of pre-configured information, one second information of the group that is relevant for interpreting the coded packet is derivable.

21. Communication participant, in particular a transmitter and/or a receiver, configured to transmit at least one data packet with a header and a coded packet into which one or several source packets are coded according to an information of the header, wherein the header comprises, from a group, at least one first information relevant for interpreting the coded packet, wherein the group comprises one or several of the following information:
information with respect to one or several sources of the coded packet and information with respect to one or several sinks of the coded packet or information with respect to one or several sources or sinks of the coded packet in combination with information with respect to a transmission direction, wherein the information is directly or indirectly comprised by the header:
a coding vector together with information with respect to one or several sources of the coded packet and information with respect to one or several sinks of the coded packet or a coding vector together with information with respect to one or several sources or sinks of the coded packet in combination with information with respect to a transmission direction, wherein the coding vectors is comprised separately, comprised integrally, pre-specified, or referenced, wherein coding coefficients are allocated to the coding vector, wherein the information is directly or indirectly comprised by the header; and
wherein the communication participant is configured to derive, from the at least one first information under consideration of pre-configured information, one second information of the group that is relevant for interpreting the coded packet.

22. System with at least one communication participant according to claim 21 functioning as a transmitter and one communication participant according to claim 21 functioning as a receiver.

23. System according to claim 22, comprising a further communication participant according to claim 21 functioning as a forwarder; and/or comprising a further communication participant according to claim 21 functioning as further transmitter or further receiver.
